(19) United States
(12) Patent Application Publication
(10) Pub. No.: US 2008/0121806 A1
(43) Pub. Date: May 29, 2008

(54) Wavelength shifting lightguides for optimal photodetection in light-sharing applications

(76) Inventor: Ron Grazioso, Knoxville, TN (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/605,803

(22) Filed: Nov. 29, 2006

(51) Int. Cl. G01T 1/164; G01T 1/20

(52) U.S. Cl. 250/363.03; 250/370.11

(57) ABSTRACT

A scintillation detector for PET imaging devices includes a wavelength shifting material for shifting the emission wavelength of a scintillator toward the peak wavelength sensitivity of a photodetector array coupled to receive light from the scintillator. Preferably the scintillator is an LSO scintillator and the photodetector array is a silicon-based array such APDs or SiPMs.

### TECHNICAL FIELD

The present invention relates to the field of nuclear medical imaging, such as Positron Emission Tomography (PET). In particular, the present invention relates to improvements in light collection efficiency of PET detectors.

### BACKGROUND OF THE INVENTION

Medical imaging is one of the most useful diagnostic tools available in modern medicine. Medical imaging allows medical personnel to non-intrusively look into a living body in order to detect and assess many types of injuries, diseases, conditions, etc. Medical imaging allows doctors and technicians to more easily and correctly make a diagnosis, decide on a treatment, prescribe medication, perform surgery or other treatments, etc.

In traditional PET imaging, a patient is injected with a radioactive substance with a short decay time. As the substance undergoes positron emission decay, it emits positrons which, when they collide with electrons in the patient's tissue, emit two high energy (e.g. 511 keV), simultaneous gamma rays at substantially opposite directions. These rays emerge from the patient's body and eventually reach a pair of scintillators positioned around the patient. There are often a ring of scintillators surrounding the patient. When the gamma rays interact with (i.e., are absorbed by) a scintillator, a number of light photons are emitted from the scintillation material. The light is usually transmitted through a lightguide to a photodetector. The light detected by the photodetector is then converted to an electrical signal, which is processed by computational circuitry of the apparatus to determine the spatial location and energy of the light signal.

In PET as well as SPECT it is important to match the scintillator emission wavelength to the optimal wavelength quantum efficiency (QE) of the photodetector. For example, a typical photomultiplier tube (PMT) used in PET applications has a peak wavelength sensitivity at 420 nm while a typical scintillator used in PET (LSO) emits at 420 nm. Therefore, PMTs and LSO are very well matched in terms of wavelength matching. LSO is a very good scintillator for PET because of its high density, high light output, and non-hygroscopic characteristics, but it is not well matched for use with other types of photodetectors, such as avalanche photodiodes (APDs), silicon photomultipliers (SiPMs), or other solid-state based photodetectors. These silicon photodetectors usually have a peak wavelength sensitivity at ≧500 nm. The QE of some devices, such as SiPMs, may increase 2-3 times from 420 nm to >500 nm. It is difficult to make a scintillator material with good PET properties and to make it emit at a certain desired wavelength. As such, there remains a need in the art to match the emission wavelength of PET scintillators to the peak wavelength sensitivity of solid-state photodetectors such as silicon-based photodetectors, to increase the quantum efficiency of such photodetectors.

### SUMMARY OF THE INVENTION

The present invention solves the existing need in the art by providing a PET detector system having a wavelength shifting device that shifts the emission wavelength of a scintillator optimized for PET detection towards a peak sensitivity wavelength of a solid-state detector. Wavelength shifting materials absorb light of a first wavelength, such as a low wavelength, higher energy lightwave and re-emit the light at a second wavelength, such as a higher wavelength, lower energy lightwave.

According to a first embodiment, a block detector is provided. The detector is comprised of a scintillator array, which is coupled to a wavelength shifting lightguide. The wavelength shifting lightguide is further coupled to a plurality of photodetectors.

In a second embodiment, a scintillator array is coupled to a lightguide. The entry surface of the lightguide is coated with a wavelength shifting coating. Finally an array of photodetectors is coupled to the wavelength shifting lightguide.

In a third embodiment, a scintillator array is coupled to a lightguide. The exit surface of the lightguide is coated with a wavelength shifting coating. Finally a photodetector is coupled to the wavelength shifting lightguide.

According to another aspect of the invention, a PET scanner is provided. The PET scanner includes a number of scintillators with a wavelength shifting material coupled to each scintillator. The PET scanner also includes a number of photodetectors coupled to the wavelength shifting materials, a processor for receiving data from the photodetectors, and software running on the processor for analyzing the data from the photodetectors and for creating and outputting an image.

### BRIEF DESCRIPTION OF THE DRAWINGS

The invention will now be described in greater detail in the following by way of example only and with reference to the attached drawings, in which:

FIG. 1 is a depiction of a conventional block detector.

FIG. 2 is a depiction of a block detector where the normal lightguide is replaced by a wavelength shifting lightguide, in accordance with an embodiment of the present invention.

FIG. 3 is a depiction of a block detector where the entry surface of the lightguide has a wavelength shifting coating, in accordance with another embodiment of the present invention.

FIG. 4 is a depiction of a block detector where the exit surface of the lightguide has a wavelength shifting coating, in accordance with yet another embodiment of the present invention.

FIG. 5 is a graph showing the absorption and emission wavelengths of an example wavelength shifting material.

FIG. 6 is a schematic of a PET scanner using a wavelength shifting material.

FIG. 7 is a graph showing a transmission spectrum of a wavelength shifting material in accordance with the invention.

FIG. 8 is a graph comparing transmission spectrum results for a SiPM with and without a wavelength shifting material in accordance with the invention.

### DETAILED DESCRIPTION OF THE INVENTION

As required, disclosures herein provide detailed embodiments of the present invention; however, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

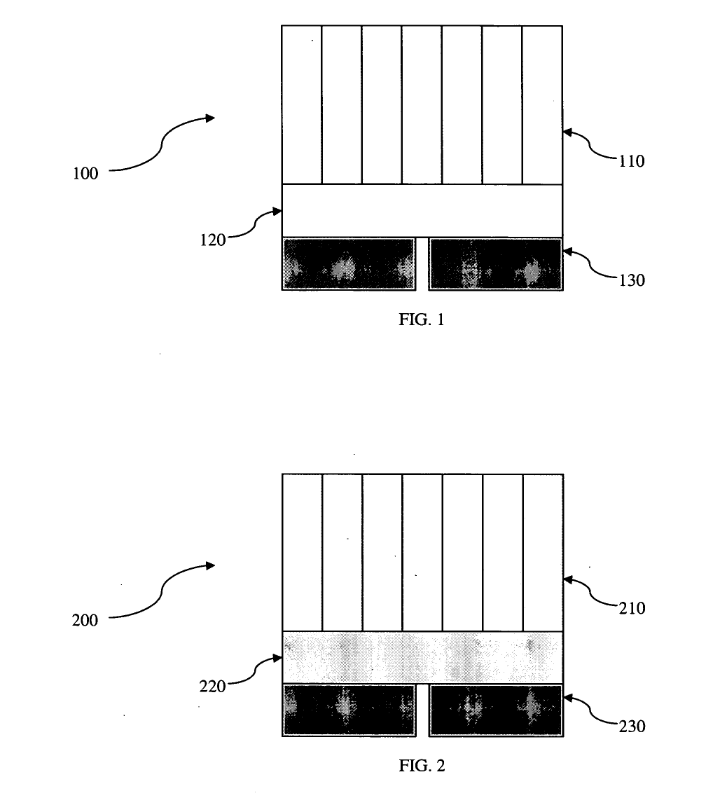

FIG. 1 depicts a typical block detector 100 used in medical imaging. The block detector 100 has a scintillator array 110. When a gamma photon is absorbed in the scintillator array 110, it emits light photons. The light photons travel out of the scintillator array 110 and into a lightguide 120 where the light photons are guided to photodetectors 130. Often, lightguide 120 is made of optical fibers and is used to transport the light to the photodetectors 130 that are located at a distance from the scintillator array 110.

FIG. 2 depicts an embodiment of a block detector 200 in accordance with an embodiment of the present invention. Block detector 200 includes a scintillator array 210. The light emitted from scintillator array 210 in response to gamma-ray interaction is absorbed by a wavelength shifting lightguide 220. Wavelength shifting lightguide 220 absorbs the light and re-emits it at a different wavelength, shifted towards the peak wavelength sensitivity of photodetectors 230. Wavelength shifting lightguide 220 may be a lightguide doped with a wavelength shifting chemical, a dye, a plastic, or any other wavelength shifting material. A typical known wavelength shifting material known as BC-482A (polyvinyltoluene) made by Saint Gobain, has an absorption peak at 420 nm and an emission peak at 494 nm. The shifted-wavelength light re-emitted from wavelength shifting lightguide 220 may then be detected by the photodetectors 230. The scintillator could be made of any appropriate scintillation material, such as LSO, crystal material or other type of material.

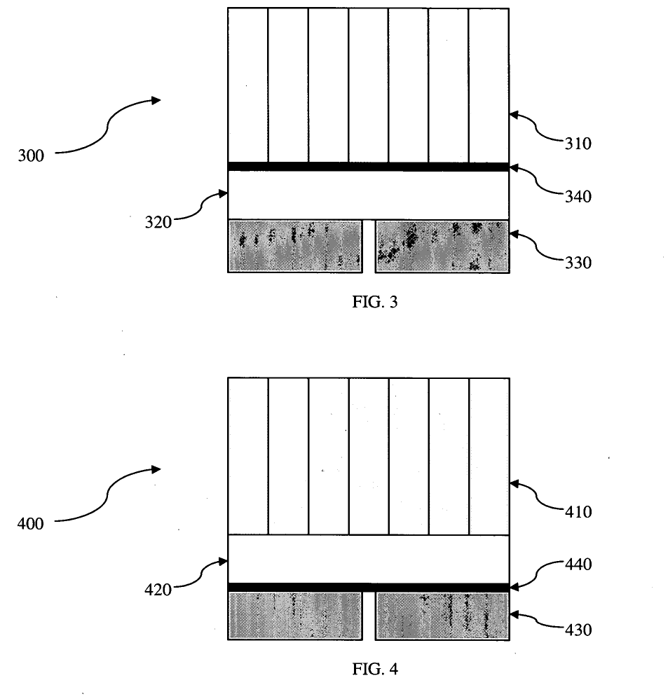

FIG. 3 depicts a second embodiment of the invention in the form of block detector 300. Block detector 300 includes a scintillator array 310. The light emitted from scintillator array 310, in response to interaction with a gamma ray, may pass through a wavelength shifting coating 340 on the entry surface of an optical lightguide 320. As the light passes through wavelength shifting coating 340, the wavelength increases as the energy of the light photons is partially dissipated in the wavelength shifting coating. The coating may be a wavelength shifting chemical, a dye, a plastic, or any other wavelength shifting material. The light is then transmitted through lightguide 320 to photodetectors 330.

FIG. 4 depicts a third embodiment of the invention in the form of block detector 400. Block detector 400 includes a scintillator array 410. The light emitted from scintillator array 410, in response to interaction with a gamma ray, is transmitted through optical lightguide 420. As the light exits lightguide 420, it passes through a wavelength shifting coating 440 on the exit surface of lightguide 420. As the light passes through wavelength shifting coating 440, the wavelength increases. The coating may be a wavelength shifting chemical, a dye, a plastic, or any other wavelength shifting material. The light then reaches photodetectors 430.

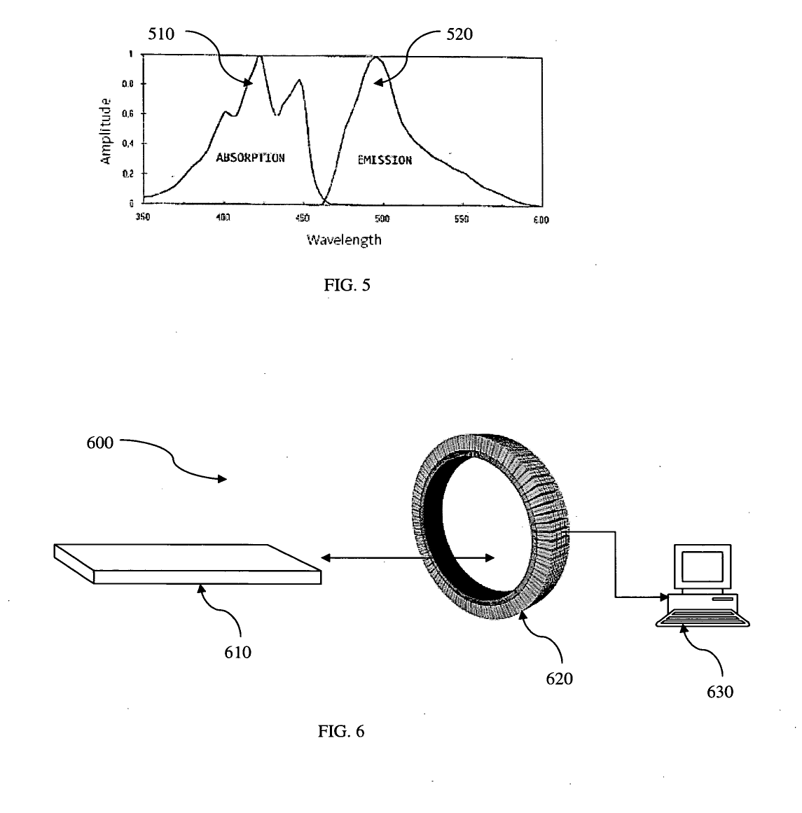

FIG. 5 is a graph showing the ranges of an absorption spectrum 510 and an emission spectrum 520 of a typical wavelength shifting material BC-482A made by Saint Gobain. Such wavelength shifting material may have an absorption peak at 420 nm and an emission peak at 494 nm. If such a material were used in place of an optical lightguide it would increase the light collection of APDs from 70% to over 80%; with SiPMs, it may increase the number of photons collected by a factor of 4. There may be some attenuation losses due to using a wavelength shifting material, but the light collection gains would be much larger than the losses.

FIG. 6 is a diagram of a PET scanning system 600 using a wavelength shifting material in the block detector in accordance with another aspect of the invention. PET scanning system 600 consists of a number of block detectors 620. The block detectors may be arranged in a ring configuration. The ring of block detectors 620 forms a space large enough for an adult human body to pass through. Each block detector may consist of a scintillator array, a wavelength shifting material and a photodetector. The ring of block detectors 620 may be connected to a processor 630. Processor 630 is capable of analyzing the data received from the ring of block detectors 620, reconstructing an image from the acquired data, and outputting tomographic images of the object or patient scanned. PET scanning system 600 may further include a table or other support structure 610 capable of holding the object or patient to be scanned. The table or other support structure 610 may be adapted to pass through the bore formed by the ring of block detectors 620.

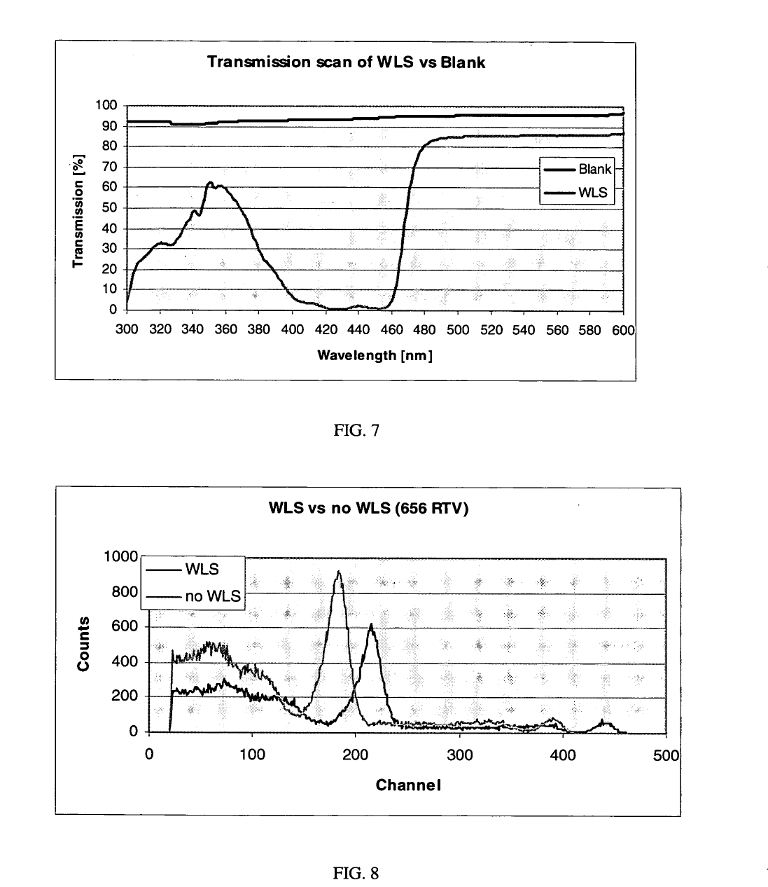

FIG. 7 shows transmission spectra for a wavelength shifting material commercially available and manufactured by Eljen Technologies, versus a blank. The material is 0.25 mm thick and was applied to a scintillation crystal as described above. The graph illustrates that the material effectively absorbs all light on the order of 420 nm and shifts it to the range of approximately 500 nm, while the blank transmission has a relatively flat spectrum.

FIG. 8 shows comparative results for a SiPM with a wavelength shifting material according to the invention, versus no wavelength shifting material. Using the wavelength shifting material resulted in an increase of ˜18% in light collection as well as an improvement in energy resolution.

The invention having been thus described, it will be apparent to those skilled in the art that the same may be varied in many ways without departing from the spirit and scope of the invention. Any and all such modifications are intended to be covered within the scope of the following claims.

What is claimed is:

1. A scintillation detector comprising:
a scintillator;
a wavelength shifting device coupled to the scintillator; and
a photodetector array coupled to the wavelength shifting device.

2. The scintillation detector of claim 1, wherein the wavelength shifting device increases a wavelength of light emitted from the scintillator.

3. The scintillation detector of claim 1, wherein the photodetector array is silicon-based.

4. The scintillation detector of claim 3, wherein the photodetector array is formed of APDs.

5. The scintillation detector of claim 3, wherein the photodetector array is formed of SiPMs.

6. The scintillation detector of claim 1, wherein the wavelength shifting device is composed of polyvinyltoluene.

7. The scintillation detector of claim 1, wherein the scintillator is a crystal.

8. The scintillation detector of claim 1, wherein the scintillator is made of LSO.

9. A scintillation detector comprised of:
a scintillator;
a lightguide coupled to the scintillator;
a wavelength shifting coating on a surface of the lightguide facing said scintillator; and
a photodetector array coupled to the wavelength shifting lightguide at a second surface thereof.

10. The scintillation detector of claim 9, wherein the wavelength shifting coating increases a wavelength of light emitted from the scintillator.

11. The scintillation detector of claim 9, wherein the photodetector is silicon-based.

12. The scintillation detector of claim 11, wherein the photodetector array is formed of APDs.

13. The scintillation detector of claim 11, wherein the photodetector array is formed of SiPMs.

14. The scintillation detector of claim 9, wherein the wavelength shifting coating is composed of polyvinyltoluene.

15. The scintillation detector of claim 9, wherein the scintillator is a crystal.

16. The scintillation detector of claim 9, wherein the scintillator is made of LSO.

17. A scintillation detector comprised of:
a scintillator;
a lightguide coupled to the scintillator;
a wavelength shifting coating on a surface of the lightguide opposite said scintillator; and
a photodetector coupled to the lightguide at said surface containing said wavelength shifting coating.

18. The scintillation detector of claim 17, wherein the photodetector is silicon-based.

19. The scintillation detector of claim 18, wherein the photodetector array is formed of APDs.

20. The scintillation detector of claim 18, wherein the photodetector array is formed of SiPMs.

21. The scintillation detector of claim 17, wherein the wavelength shifting coating is composed of polyvinyltoluene.

22. The scintillation detector of claim 17, wherein the scintillator is a crystal.

23. The scintillation detector of claim 13, wherein the scintillator is made of LSO.

24. A positron emission tomography (PET) scanner comprising:
a plurality of scintillation detector modules, each module comprising
a scintillator;
a wavelength shifting material coupled to said scintillator;
a plurality of photodetectors coupled to the wavelength shifting material;
a processor for receiving PET data from the photodetectors; and
software executing on the processor for analyzing the data from the photodetectors and for reconstructing an image based on said PET data.

25. The PET scanner of claim 24, wherein the plurality of scintillator detector modules are arranged in a ring.

26. The PET scanner of claim 24, wherein the wavelength shifting material is composed of polyvinyltoluene.

27. The PET scanner of claim 24, wherein the wavelength shifting material is a coating on a lightguide.

28. The PET scanner of claim 24, wherein the coating is on the entry surface of the lightguide.

29. The PET scanner of claim 24, wherein the coating is on the exit surface of the lightguide.

30. The PET scanner of claim 24, wherein the wavelength shifting material also functions as a lightguide.

31. The PET scanner of claim 24, wherein the photodetectors are silicon-based.

32. The PET scanner of claim 31, wherein the photodetector array is formed of APDs.

33. The PET scanner of claim 31, wherein the photodetector array is formed of SiPMs.

34. The PET scanner of claim 24, wherein the scintillator is a crystal.

35. The PET scanner of claim 24, wherein the scintillator is made of LSO.
